(19) United States
(12) Patent Application Publication
(10) Pub. No.: US 2013/0067595 A1
(43) Pub. Date: Mar. 14, 2013

(54) Data Isolation Service for Data and Information Sharing

(71) Applicants: Lester S. Pierre, Valley Cottage, NY (US); Nader A. Chouman, Lodi, NY (US)

(72) Inventors: Lester S. Pierre, Valley Cottage, NY (US); Nader A. Chouman, Lodi, NY (US)

(73) Assignee: Wall Street Network, Inc.

(21) Appl. No.: 13/232,519

(22) Filed: Sep. 14, 2011

(51) Int. Cl. G06F 21/24

(52) U.S. Cl. 726/28; 726/26

(57) ABSTRACT

A Data Isolation Service for data, information, and knowledge sharing giving organizations using any type of software solution the ability to provide the public with certain public declassified information using a public facing instance of the same software solution. The Data Isolation Service allows for sensitive data to remain secure using a hybrid data storage model. This hybrid model allows for all data to remain secure without the risk that the private data becomes compromised when sharing public data. The Data Isolation Service can be used with any software technology and application system. The Data Isolation Service is a technology service that keeps private and public data partitioned allowing for the transport of public declassified data from within the organization or private database to a public database for public use, then allowing the public declassified data to re-enter the private database for internal organization use.

### BACKGROUND OF THE INVENTION

### Field of the Invention

The majority of organizations and individuals today utilize technology in some way to organize proprietary and confidential information. Many organizations and individuals use technology as a means for sharing their information and knowledge to advance their business. However, the use of technology for such important information and data also brings with it multiple risks that proprietary and confidential information inadvertently becomes public due to security breaches, misuse, and even piracy. Multiple uses are in place for expanding inter-office network use with Enterprise Content Management (ECM) applications, Customer Relationship Management (CRM) applications, Enterprise Content Management and Collaboration (ECMC) applications, Knowledge Management (KM) applications, and Cloud Computing using cloud technology. All mentioned application types allow for extreme data, content and knowledge management and sharing; but all applications also have the risk that important information can be leaked when certain portions are allowed to be public facing, causing disastrous results. Because the risks outweigh the benefits of using the ever-evolving technology that is in existence for data sharing and organization, it is extremely difficult for organizations and individuals to trust any type of technology being used and are forced to refrain from using beneficial applications to their full potential.

The present invention is a Data Isolation Service which allows for sensitive data to remain secure using a hybrid data storage model. This hybrid model allows for all data, including proprietary and confidential information, to remain secure without the risk that the private data in the application becomes compromised when sharing public data. The Data Isolation Service can be used with any software technology and application system and allows for the secure sharing of data, meaning that sensitive and private data remains private while data that is acceptable for public viewing and sharing can be viewed and shared without running the risk that private data leaks into the public. The Data Isolation Service is a technology service that keeps private and public data partitioned allowing for transport of public declassified data from within the organization or private database to a public database for public use, then allowing the public declassified data to re-enter the private database for internal organization use. This is done by connecting two separate data sources with the Data Isolation Service, both data sources maintained autonomously, with the two data sources only knowing of the public, or declassified data, moving between them.

The current private and public data separation systems are query based, meaning systems that allow for information retrieval within databases and information systems using text entered by users to search for data. While security measures do exist regarding who, what, when, and where certain types of data can be accessed, query computing is not trusted since it allows unauthorized users to get a hold of private data either inadvertently, accidentally, or through hacking. As such, all organizations having proprietary or top secret data, for example government agencies, will never use the existing systems to share, or even store their data. There also exist solutions for infernal data sharing, such as sharing data between internal networks, but this does not allow for public, declassified information to be shared with the public. Secure public data sharing without running the risk of private data being retrieved is necessary for the advancement of business. By sharing public data, organizations and individuals can better communicate with their clients, prospects or agencies needing their public facing data. All industries have a process for exchanging data when dealing with partners and clients, and a system that allows for data sharing and application use without the risk of private data being leaked, which also eliminates the preparation time for producing secure documents containing the required data, is necessary. The present invention solves this problem, without the risk of security breaches.

### SUMMARY OF THE PRESENT INVENTION

The present invention relates generally to knowledge and data sharing, and more specifically, to a Data Isolation Service to be used with any type of software solution allowing for data storage and knowledge transfer for the purpose of sharing public, declassified data stored in internal but public databases and allowing the public to view, use and even import allowed data for use by organizations and individuals wishing to keep their private data private. The present invention provides a solution whereby the private users of such may keep private data and public data separate and allow public users to view the public data in a way that is beneficial to the private users of an organization or business without the risk of private data being compromised.

A primary object of the present invention is to provide a Data Isolation Service for public data and knowledge sharing using existing software solutions which allows public data and private data within the software solution to each be isolated from the other.

Another object of the present invention is to provide a Data Isolation System for public data and knowledge sharing allowing for public declassified data access by external users while restricting access to private data by external users.

Yet another object of the present invention is to provide a Data Isolation Service for public data and knowledge sharing which allows businesses to share public data using the business' existing software solutions.

Still yet another object of the present invention is to provide a Data Isolation Service for public data and knowledge sharing which protects private data and knowledge contained in software solutions.

Another object of the present invention is to provide a Data Isolation Service for public data and knowledge sharing which keeps public and private data partitioned using a hybrid data storage model.

Yet another object of the present invention is to provide a Data Isolation Service for public data and knowledge sharing where private data is stored in a private database and public data is stored in a public database within the hybrid data storage model where the private database and public database are maintained autonomously and contain the same instance of the software application for private data use by private database users and public data use by public external database users.

Still yet another object of the present invention is to provide a Data Isolation Service for public data and knowledge sharing having the ability to allow transport of solely the public declassified data from the private database into the public database using cloud computing technology.

Another object of the present invention is to provide a Data Isolation Service for public data and knowledge sharing which allows transport of external data contributed by external users of the public instance of the software solution into the private instance of the software solution for private use by internal users of the private instance of the software solution using cloud computing technology.

Yet another object of the present invention it to provide a Data Isolation Service assisting the application in allowing certain internal application features to be available to the public without the risk of exposing private data while excluding functionality that is private.

The present invention overcomes the shortcoming of the prior art by providing a means for sharing and retrieving public declassified data without the use of query computing or the use of multiple internal networks while using software applications, including but not limited to, content and knowledge management applications. Nowhere in the prior art exists a Data Isolation Service having the ability to transfer specified public data and knowledge without the risk that the public data and private data may inter-mix or lead to confusion within the technology separating the public and private databases causing a leak of private data.

The foregoing and other objects and advantages will appear from the description to follow. In the description, reference is made to the accompanying drawings, which forms a part hereof, and in which is shown by illustration of specific embodiments in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a flow diagram illustrating one example of the Data Isolation System;

FIG. 2 is a sectional view of the Data Isolation System illustrating one example of an On-Premise Application;

FIG. 3 is a sectional view illustrating one example of the Data Isolation Service;

FIG. 4 is a sectional view of the Data Isolation System illustrating one example of a Cloud Application; and

FIG. 5 is a flow diagram illustrating one example of how an application may utilize the Data Isolation System.

### DETAILED DESCRIPTION OF THE DRAWING FIGURES

The following discussion describes in detail one embodiment of the present invention and several variations of that embodiment. This discussion should not be construed, however, as limiting the invention to those particular embodiments; practitioners skilled in the art will recognize numerous other embodiments as well. For definitions of the complete scope of the invention, the reader is directed to the appended claims.

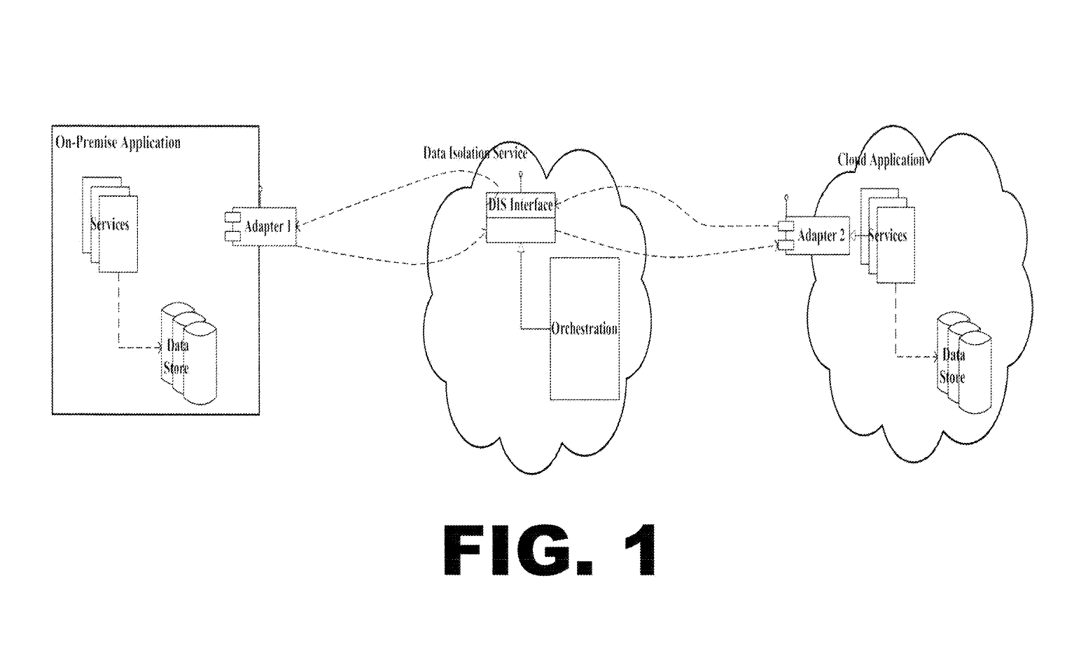

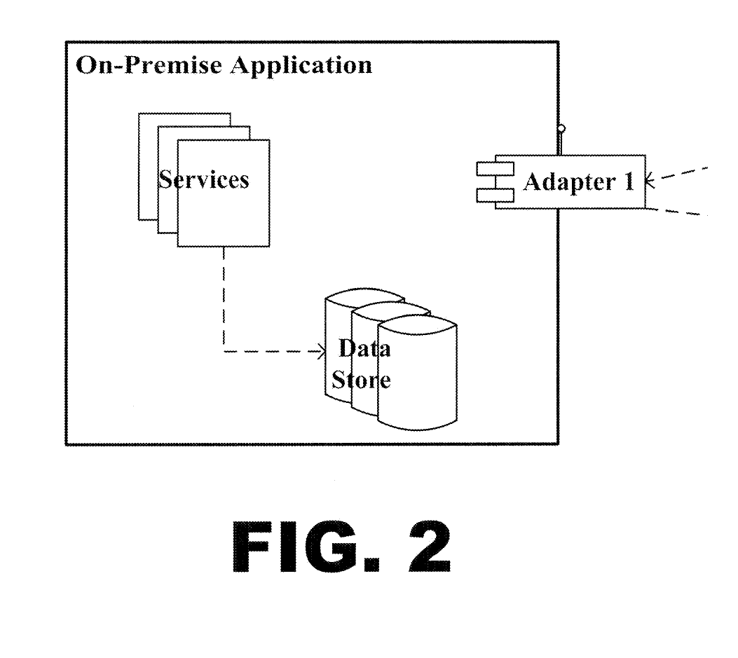

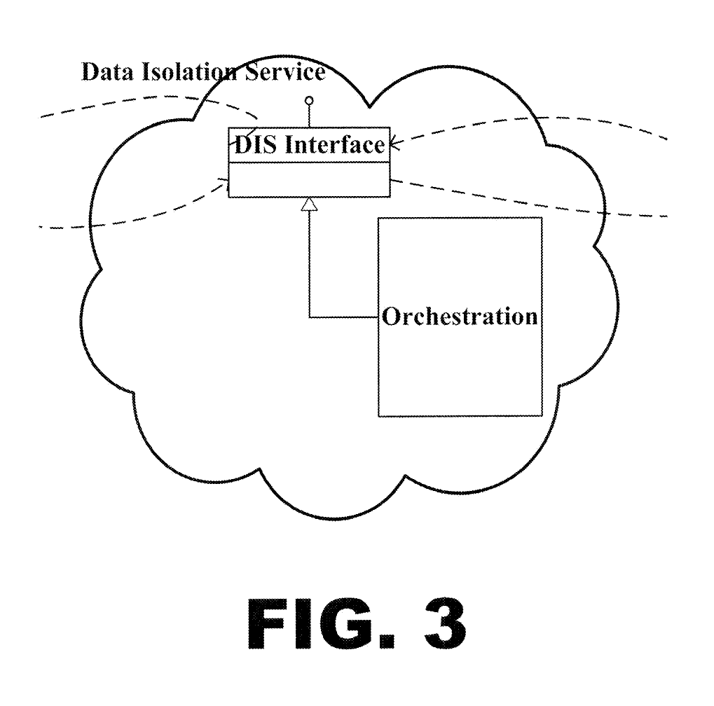

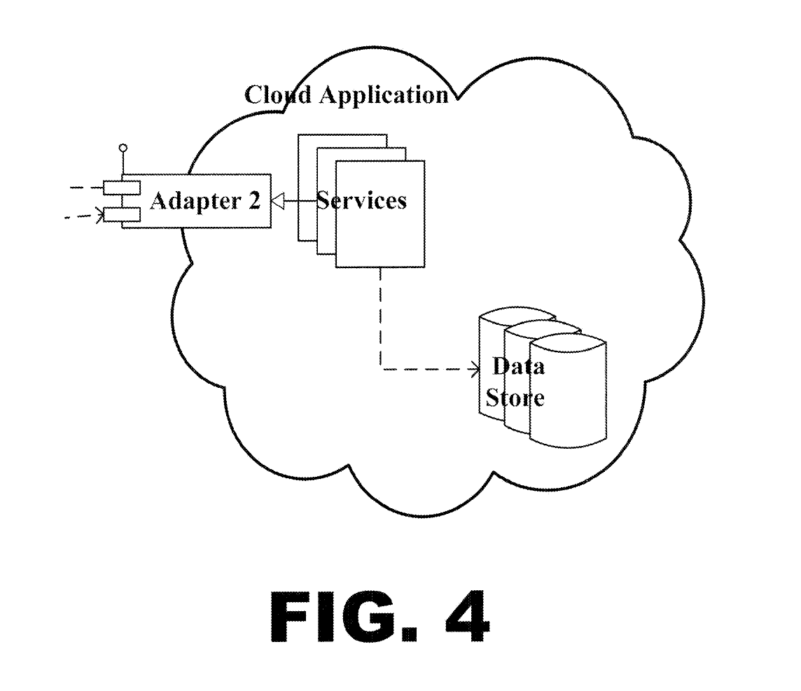

FIG. 1 is a flow diagram illustrating one example of the Data Isolation System. FIGS. 2, 3, and 4 are sectional views of the flow diagram illustrated in FIG. 1. The Data Isolation System requires the application whose data is being isolated to have multiple instances; one on-premise application instance, which is local to an organization, and one off-premise instance which is a cloned copy of the features and functionality of the on-premise application that can be shared with the public. Shown is the Data Isolation System (FIG. 3), which is a connector between a private, on-premise deployed instance of an application (FIG. 2) in an on-premise network, typically a server, to a public, off-premise deployed instance in an alternate system. Shown is the off-premise instance in a cloud (FIG. 4) using cloud computing technology, which is not limited to such. Other embodiments are also available, such as placing the second instance of an application on separate servers across data centers. The Data Isolation Service is responsible for creating mockups of data from a source data store, a data store in the on-premise instance of an application, to a destination data store, a data store in the cloud instance of the application. This data store created in the cloud, based on the on-premise data store, is to manage data in the same way that data is managed in the on-premise instance. The service is an orchestrating service that may be used by applications to synchronize business data across multiple data centers. The synchronization is intended to allow secure access of public data to the public without the risk of exposing private data from the application that is using the service.

The Data Isolation service has an interface that any application can interact with. The service is aware of addresses of the cloud data store as well as the on-premise data store for the service's connection to both and the level of security of the connection that is required based on the type and structure of the data the service will be moving back and forth between the on-premise instance and the cloud instance of the application. The service transmits data in a uniform notion, including but not limited to External Markup Language (XML) and binary code, without regards to what the application's structure is. In order for the application to use the Data Isolation Service, the application has the ability to transform the data being submitted from a structure familiar to the application itself to a structure familiar to the data isolation service. In the same way, when receiving a message from the Data Isolation Service, the application also has the ability to transform the received data from the structure familiar to the Data Isolation Service back to the structure familiar to the application itself. This transformation of structured data representation to the generic representation may be handled by an Adapter, which is specifically created for each application making use of the Service. This Adapter may then connect to an Enterprise Service Bus, which in various implementations may be MICROSOFT BizTalk. The Data Isolation Service will expose an interface, per Adapter, as the intermediate service between the application and the Data Isolation Service. This allows the on-premise application to connect to both the on-premise data store and the cloud data store, allowing the cloud instance of the application to connect only to the cloud store, allowing for the sharing of public data only. The cloud instance may have its own authentication security for public access based on the requirements for each business. The Data Isolation Service is called by the application to move public data from the on-premise instance to the cloud instance and vice-versa. The Service then moves the requested public data back and forth whenever notified by the on-premise instance.

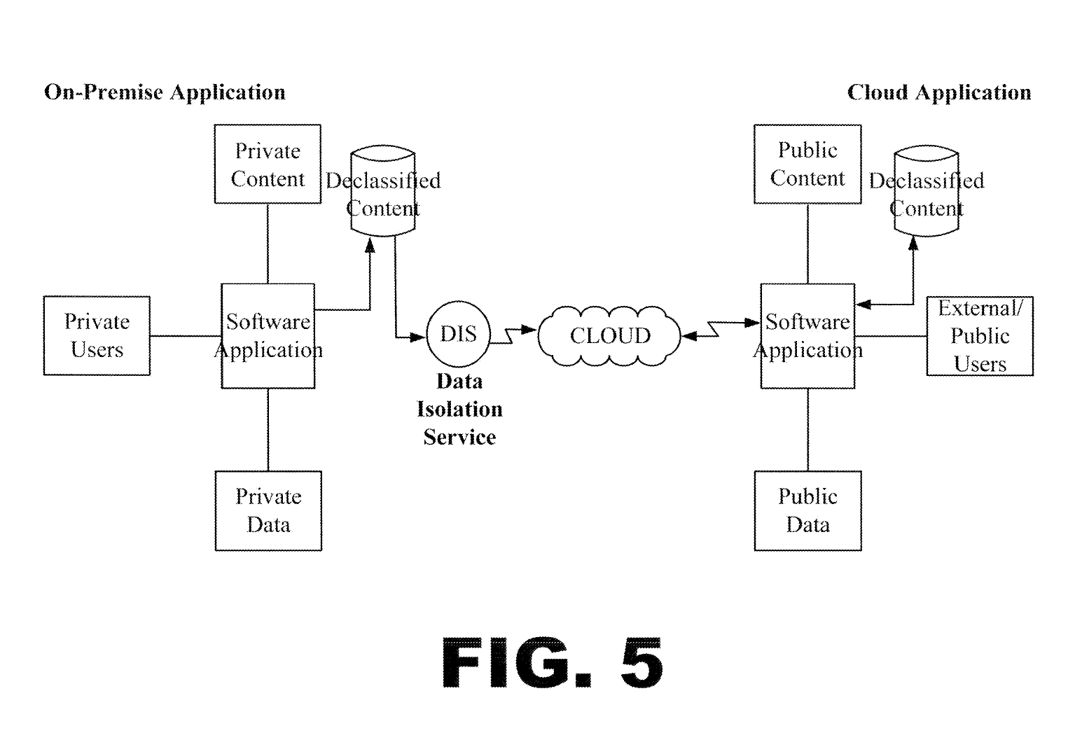

FIG. 5 is a flow diagram illustrating one example of how an application may utilize the Data Isolation Service. Once one instance of the application has been deployed on-premise, a second, public facing instance is deployed in another data center containing the desired features and functionality of the on-premise instance. Shown is the second instance deployed to a cloud. The on-premise application may contain the Software Application, Private Content, and Private Data all accessible by Private Users. All portions of the on-premise application in some way play a part in placing content in the Declassified Content Database then communicates with the Data Isolation Service, then the Cloud, which is all shown. The Data Isolation Service may either be placed in the cloud or in the on-premise server where the on-premise application is located. The cloud application is the second instance of the application containing the Software Application, Public Content and Public data all accessible by Public Users. All portions of the cloud application either store or retrieve public data from the Declassified Content Database. Depending on what an organization would like the application to do, data that has been declassified, public data, is stored in this separate Declassified Content database. This database containing Declassified Content is also duplicated in the cloud instance of the application. The two Declassified Databases exchange data of the Data Isolation Service via the application, as called by either private users using the private, on-premise instance or public users using the public, cloud instance. Security measures may be implemented in the on-premise instance to determine what types of content can be placed in the on-premise Declassified Content database when private users desire to upload new content into the Declassified Database for transport into the cloud instance.

What is claimed is new and desired to be protected by Letters Patent and is set forth in the appended claims:

1. A Data Isolation Service for data and information sharing allowing public data and private data within a software solution to each be isolated from the other.

2. The Data Isolation Service for data and information sharing according to claim 1, further comprising a means for allowing public declassified data access by external users of a software solution while restricting access to private data.

3. The Data Isolation Service for data and information sharing according to claim 2, further comprising a means to protect private data and information contained in a software solution.

4. The Data Isolation Service for data and information sharing according to claim 1, wherein public data and private data are isolated using a Hybrid Data Storage model.

5. The Data Isolation Service for data and information sharing according to claim 4, wherein said Hybrid Data Storage model comprises installing identical instances of a software solution across two separate data centers one instance being internal and one instance being external.

6. The Data Isolation Service for data and information sharing according to claim 5, wherein said Hybrid Data Storage model further comprises private database for storage of private data and a public database for storage of public data where the private database and public database are maintained autonomously and contain identical instances of a software application using the Data Isolation Service.

7. The Data Isolation Service for data and information sharing according to claim 6, further comprising, a means to allow transport of the public data from the private database into the public database in separate data centers.

8. The Data Isolation Service for data and information sharing according to claim 7, further comprising a means for transporting external data contributed by external users of a public instance of a software solution into the private instances of the software solution for private use by internal users of the private instance of a software application.

9. The Data Isolation Service for data and information sharing according to claim 5, further comprising a means for allowing certain internal software solution features to be available to the public without risk of exposing private data and excluding functionality that is private.
